(19) United States
(12) Patent Application Publication
(10) Pub. No.: US 2012/0179485 A1
(43) Pub. Date: Jul. 12, 2012

(54) SYSTEMS AND METHODS FOR INTEGRATED CARE MANAGEMENT

(75) Inventor: Kian Saneii, San Diego, CA (US)

(73) Assignee: Independa, Inc., San Diego, CA (US)

(21) Appl. No.: 13/345,596

(22) Filed: Jan. 6, 2012

Related U.S. Application Data
(60) Provisional application No. 61/430,826, filed on Jan. 7, 2011.
(60) Provisional application No. 61/558,130, filed on Nov. 10, 2011.

(51) Int. Cl. G06Q 50/22

(52) U.S. Cl. 705/2

(57) ABSTRACT

Systems and methods for managing the care of care receivers using a care management system are disclosed. One embodiment includes a care management server configured to communicate with at least one care provider client, where the care provider client is configured to provide a user interface for receiving care management instructions; where the care management server is configured to receive care management instructions from the at least one care provider client and store the care management instructions in a care management database; receive data concerning the status of a care recipient and store the received data concerning the status of the care recipient in the care management database; analyze the data concerning the status of the care recipient within the care management database in accordance with the care management instructions; and send notifications to the care provider client based upon the analysis of the care management database.

### CROSS-REFERENCE TO RELATED APPLICATIONS

The current application claims priority to U.S. Provisional Patent Application No. 61/430,826, filed Jan. 7, 2011, the disclosure of which is incorporated herein by reference, as well as U.S. Provisional. Patent Application No. 61/558,130, filed Nov. 10, 2011 the disclosure of which is incorporated herein by reference.

### FIELD OF THE INVENTION

The present invention is generally related to care management and more specifically to management of care receiver devices by a care provider client and a care management server.

### BACKGROUND OF THE INVENTION

Effective care management is important for care providers, such as loved ones or health care professionals, who look after care receivers, such as the elderly, injured or invalids. Advances in health care have improved the life expectancy and comfort of care receivers. However, similar strides have not been made in the realm of care management. This creates a greater demand upon care providers who are entrusted to ensure the comfort, health and security of care receivers.

Situations can arise where a care provider, such as a loved one or relative, is no longer able to effectively manage the care of their care receiver. For example, providing care for the elderly can become increasingly difficult as the elderly lose independence with age. When the difficulty for care providers to look after their care receivers becomes too burdensome, the responsibility for caring for care receivers is often performed by professionals or specialized care environments such as nursing homes. However, utilization of care professionals and/or specialized care environment can increase the financial cost of care and in some cases the emotional burden of no longer being able to personally take care of a care receiver such as a loved parent, relative or friend.

### SUMMARY OF THE INVENTION

Systems and methods for managing the care of care receivers using a care management system are disclosed. One embodiment includes a care management system including a care management server configured to communicate with at least one care provider client, where the care provider client is configured to provide a user interface for receiving care management instructions; where the care management server is configured to receive care management instructions from the at least one care provider client and store the care management instructions in a care management database; receive data concerning the status of a care recipient and store the received data concerning the status of the care recipient in the care management database; analyze the data concerning the status of the care recipient within the care management database in accordance with the care management instructions; and send notifications to the care provider client based upon the analysis of the care management database.

In a further embodiment, the care management server is further configured to receive data concerning the status of a care recipient using automated user interface interactions via a telephone, and send automatically generated notifications to the telephone based upon the analysis of the care management database.

In another embodiment, the care management server is further configured to receive data concerning the status of a care recipient via a care receiver client, and send notifications to the care to the care receiver client based upon the analysis of the care management database.

In a still further embodiment, the care receiver client is configured to access content servers, and the care management server is configured to restrict the content servers that the care receiver client can access.

In still another embodiment, the care receiver client is configured to: display a game user interface; record game performance; and send game performance data to the care management server; and the care management server is further configured to: receive game performance data from the care receiver client and store the game performance data in the care management database; analyze the game performance data; and send a notification to a care provider client in response to the analysis detecting a decline in game performance.

In a yet further embodiment, the care management server is further configured to receive data concerning the status of a care recipient via a care receiver sensor.

In yet another embodiment, the care management server is further configured to communicate with at least one of a care receiver client, a care receiver sensor and a care provider client via the Internet.

In a further embodiment again, the at least one of a care receiver client and a care receiver sensor are configured to connect to the Internet using a wireless hub.

In an embodiment again, the care management server is further configured to receive data concerning the status of a care recipient via at least one of a care receiver client, and a care receiver sensor, and the care management server is configured to update the configuration settings of the at least one of a care receiver client and a care receiver sensor based upon the analysis of the data concerning the status of the care recipient in the care management database.

In a further additional embodiment at least one of a care provider client, a care receiver client, and a care receiver sensor are configured to intermittently synchronize with the care management server.

In another additional embodiment, the care management server receives scheduling data from a care receiver client.

In a still yet further embodiment, the care management database includes a database of pharmaceuticals.

In still yet another embodiment, the care management server is further configured to analyze the data within the care management database to generate a timeline of upcoming notifications, and send the timeline of upcoming notifications to at least one of a care receiver client and a care provider client, which displays a timeline of upcoming notifications via a user interface.

In a still further embodiment again, the care management server is configured to analyze the data within the care management database and send escalated notifications based upon the care management instructions stored in the care management database.

In still another embodiment again, the care management server is further configured to store data concerning the status of a plurality of care recipients in the care management database, and perform analytics to detect patterns that can be used to detect an increased likelihood of a particular status for a specific care recipient in the future.

A still further additional embodiment includes a method of managing the care of care receivers using a care management server, the method including: receiving care management instructions from a care provider client using a care management server and storing the care management instructions in a care management database; collecting data concerning the status of a care recipient using a care management server and storing the data concerning the status of the care recipient in the care management database; analyzing the data concerning the status of the care recipient within the care management database in accordance with the care management instructions stored in the care management database; and sending notifications to the care provider client based upon the analysis of the care management database.

A still another additional embodiment includes receiving data concerning the status of a care recipient using automated user interface interactions via a telephone and sending automatically generated notifications to the telephone.

A yet further embodiment again also includes receiving data concerning the status of a care recipient via a care receiver client and sending notifications to the care receiver client.

In yet another embodiment again, the care receiver client is configured to access content servers, and the method further includes restricting the content servers that the care receiver client can access using the care management server.

A yet further additional embodiment further includes: displaying a game user interface using the care receiver client; recording game performance using the care receiver client; sending game performance data to the care management server using the care receiver client; receiving game performance data from the at least one care receiver client using the care management server and storing the game performance data in the care management database; analyzing the game performance data using the care management server; and sending a notification to a care provider client in response to the analysis detecting a decline in game performance using the care management server.

A yet another additional embodiment includes receiving data concerning the status of a care recipient via a care receiver sensor.

A further additional embodiment again includes communicating between the care management server and at least one of a care receiver client, a care receiver sensor and a care provider via the Internet.

An another additional embodiment again includes connecting at least one of a care receiver client, and a care receiver sensor to the Internet via a wireless hub.

A still yet further embodiment again includes: receiving data concerning the status of a care recipient via at least one of a care receiver client, and a care receiver sensor using the care management server; and updating the configuration settings of the at least one of a care receiver client and a care receiver sensor based upon the analysis of the data concerning the status of the care recipient in the care management database using the care management server.

A still yet another embodiment again includes at least one of a care provider client, a care receiver client, and a care receiver sensor intermittently synchronizing with the care management server.

A still yet further additional embodiment includes receiving scheduling data from a care receiver client using the care management server.

In still yet another additional embodiment, the care management database includes a database of pharmaceuticals.

A still yet further additional embodiment again includes analyzing the data within the care management database to generate a timeline of upcoming notifications using the care management server, and sending the timeline of upcoming notifications to at least one of a care receiver client and a care provider client, which displays a timeline of upcoming notifications via a user interface.

A still yet another additional embodiment again includes analyzing the data within the care management database and sending escalated notifications based upon the care management instructions stored in the care management database using the care management server.

An alternate embodiment includes storing data concerning the status of a plurality of care recipients in the care management database, and performing analytics on the data stored in the care management database using a care management server to detect patterns that can be used to detect an increased likelihood of a particular status for a specific care recipient in the future.

### BRIEF DESCRIPTION OF THE DRAWINGS

FIG. 1A illustrates a system diagram of a care management system with a care management server managing care receiver clients and sensors with care provider clients in accordance with an embodiment of the invention.

FIG. 1B illustrates a system diagram of a care management system integrating care providers such as professional and personal care providers as well as an extended care network with care receivers in accordance with an embodiment of the invention.

FIG. 1C illustrates a system architecture diagram of a care management system that integrates care providers, such as individual care providers or across an extended area network with care receivers in accordance with an embodiment of the invention.

FIG. 1D illustrates a care management server with a processor, volatile memory and non-volatile memory including a care management process in accordance with an embodiment of the invention.

FIG. 2 is a flow chart illustrating a process for updating care receiver devices based upon care provider instructions using a care management server in accordance with an embodiment of the invention.

FIG. 3 is a flow chart illustrating a process for presenting a user interface to a care receiver on a care receiver client updated by a care management server in real-time, pre-scheduled, online and offline, based upon instructions received from a care provider client in accordance with an embodiment of the invention.

FIG. 4A illustrates a care receiver client graphical user interface displaying a daily medication list in accordance with an embodiment of the invention.

FIG. 4B illustrates a care receiver client graphical user interface displaying a weekly schedule of medications in accordance with an embodiment of the invention.

FIG. 5 is a flow chart illustrating a process performed by a care management server using inputs from care receiver clients or sensors where the care management server uses the data to send notifications or updates to a care receiver client, a care provider client or third party in accordance with an embodiment of the invention.

FIG. 6A illustrates a care receiver client graphical user interface displaying a scheduled reminder in accordance with an embodiment of the invention.

FIG. 6B illustrates a care receiver client user graphical interface displaying a medication reminder in accordance with an embodiment of the invention.

FIG. 7 illustrates a care receiver client user graphical interface displaying data analyzed from care receiver sensors and/or clients in accordance with an embodiment of the invention.

FIG. 8A illustrates a care receiver client user interface displaying a gaming interface in accordance with an embodiment of the invention.

FIG. 8B illustrates a care receiver client user interface displaying a single player card game in accordance with an embodiment of the invention.

FIG. 9 is a flow chart illustrating a process in which a care management server fillers requests from a care receiver client in accordance with an embodiment of the invention.

FIG. 10 illustrates a care receiver client alert screen in accordance with an embodiment of the invention.

FIG. 11 illustrates a graphical contact list selection for video conferencing on a care receiver client user interface in accordance with an embodiment of the invention.

FIG. 12 illustrates a care receiver client user interface performing a videoconference in accordance with an embodiment of the invention.

FIG. 13 illustrates messaging on a care receiver client user interface in accordance with an embodiment of the invention.

FIG. 14 illustrates selection of 3^{rd} party programs on a care receiver client user interface in accordance with an embodiment of the invention.

FIG. 15 illustrates a general graphical user interface on a care receiver client user interface in accordance with an embodiment of the invention.

FIG. 16 illustrates a help tab on a care receiver client user interface in accordance with an embodiment of the invention.

FIG. 17 illustrates a photo selection and viewing feature on a care receiver client user interface in accordance with an embodiment of the invention.

FIG. 18 illustrates a zooming feature on a care receiver client user interface in accordance with an embodiment of the invention.

### DETAILED DESCRIPTION

Turning now to the drawings, systems and methods of managing the care of care receivers using a care management system are disclosed. In many embodiments the care management system includes a care management server that receives information from care receiver clients and sensors. Care receiver clients include any device that a care receiver can use to interact with the care management system such as (but not limited to) a tablet, personal computer, Internet connected television, telephone or network connected thermostat. In many embodiments, the care receiver client is a web page, such as an HTML5 page, that can be maintained locally and served via a local server or stored on a remote server. When a user interface is constructed using web technologies, the user interface can be rendered using a web browser rendering engine. Similarly, care provider clients include any device that a care provider can use to interact with the care management system. In various embodiments, a care management server facilitates communication across all care receiver clients and sensors and communication with care provider clients and/or even third parties. By aggregating information at a care management server, the care management system can abstract specific devices and/or sensors and can create an aggregated history of measurements related to the status or condition of a care recipient using a variety of devices. In addition, the care management system can perform analytics upon the data received by the devices. The care management server analyzes data from a care receiver device such as a care receiver sensor or client and the analyzed data can be used to modify and/or update any of the care receiver clients or sensors. The analyzed data can also trigger notifications to a care provider client that accessible to an individual or a group, such as a doctor's office. The care management server can also access information within a care management database, which stores data accumulated from the care receiver clients and sensors. The care management server can use the information to perform analytics and provide updates and/or notifications based upon the results.

In many embodiments, a care provider client can manage the care of care recipient via the care management server. This can include modifying the settings on care receiver clients and sensors, controlling the type of data sent to the care management server, the settings for the analytics on the care management server, the settings of other the care receiver devices, and the settings for communication between devices.

In numerous embodiments, a care receiver client can access data across a network and/or control care receiver devices. For example, a care receiver client can access general websites, games, video chat, text chat, email, social network forums or even the analytics on a care management server or data in a care management database. A care receiver client can also adjust care receiver devices, including the settings on care receiver clients or sensors. Access for a care receiver client to any other device is generally controlled by a care management server.

In multiple embodiments, a user interface on a care receiver client is a closed environment managed by a care management server with settings determined by a care provider client. However, in other embodiments, the user interface is an open environment that can also be controlled by third parties. In certain embodiments, a user interface can rotate between several high level options such as “Health”, “Info”, “Fun”, “Web”, “Social.” and “Schedule.” Each option can be selected as a list or in a circular fashion where browsing across all categories will loop back to the initial category for browsing. Each option can also have sub options that illustrate another list of options. Additional information is also selectable on a user interface, such as general information, a help button and a search service. Information bars can also be featured with general information such as the date and time, weather and reminders.

Systems and methods for managing care for a care receiver in accordance with embodiments of the invention are discussed further below.

### System Architecture

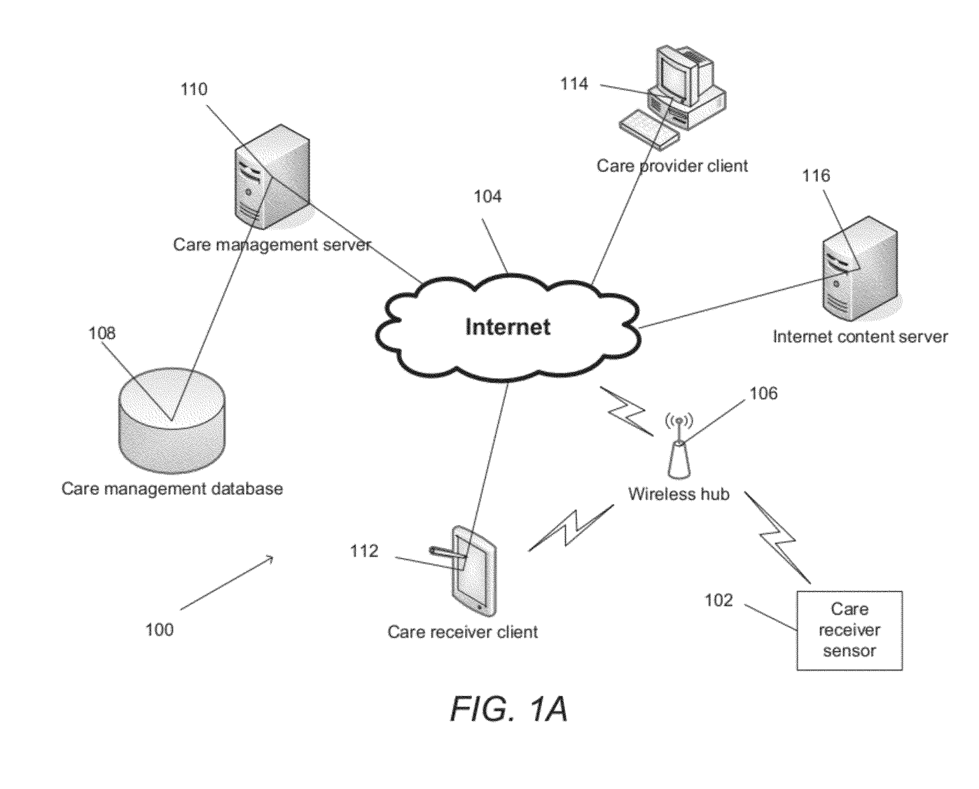

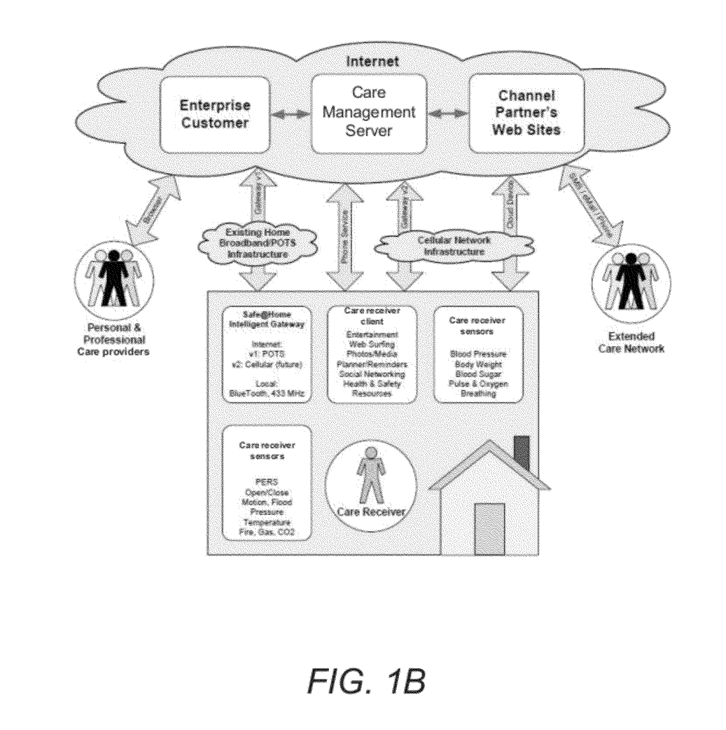

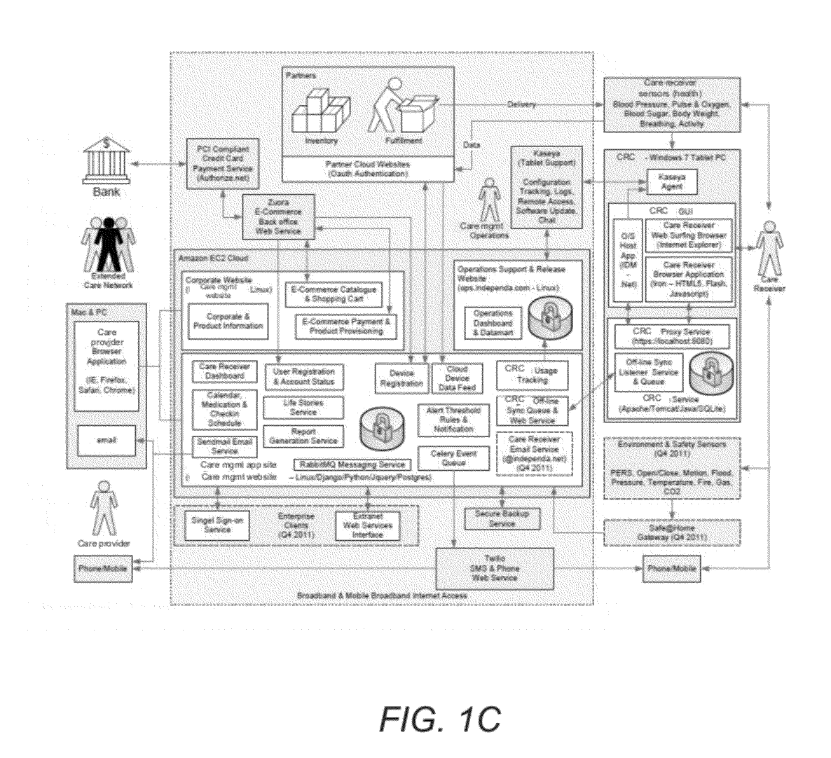

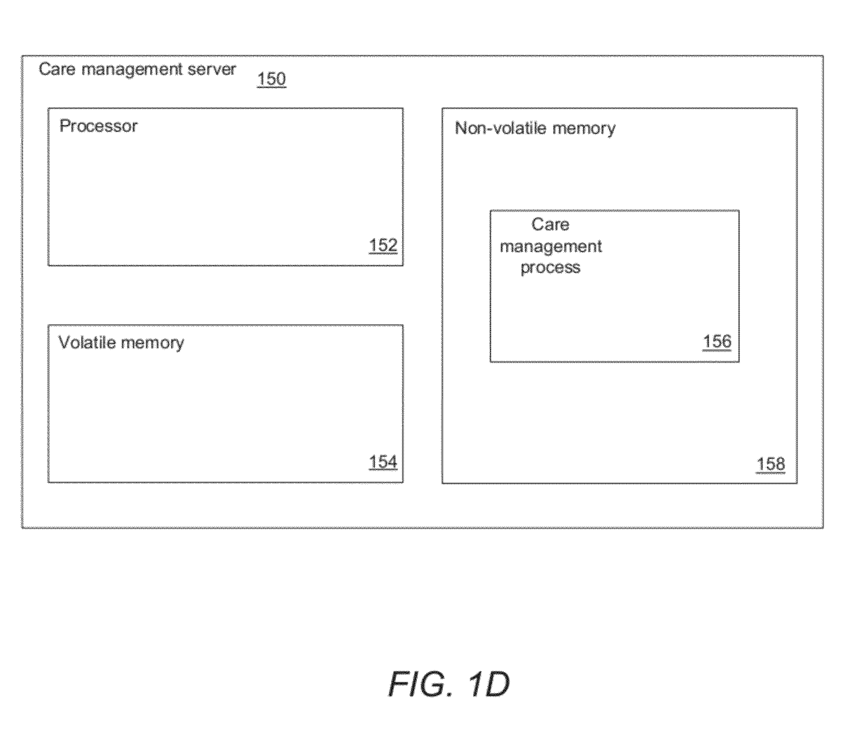

Care management for care receivers can be dictated by care providers or care receivers and coordinated using a care management server. Care receiver clients can operate while connected to a network such as the Internet through a pervasive connection or offline with periodic or intermittent synching of updates from care receiver clients and sensors with a care management server. A system diagram of a care management system in accordance with an embodiment of the invention is illustrated in FIG. 1A. The care management system 100 includes one or more care receiver sensors 102 connected to the Internet 104 via a wireless hub 106, which can includes a wireless cellular ‘cloud’ network, mobile broadband, Bluetooth technology or any other wireless connection. The connection is completely or partially wired in certain embodiments using a wired hub. A care receiver client 112 can also be connected with the wireless hub and be accordingly connected with care receiver sensors 102 or the Internet 104. A care management database 108 is connected to a care management server 110.

The Internet 104 connects each of a care management server 110, care receiver client 112, care provider client 102, 3^{rd} party Internet content server 116 and the hub 106 together. System diagrams of similar embodiments are illustrated in FIG. 1B and FIG. 1C. In FIG. 1B, the manner in which the system enables care providers, including personal and professional care providers, and an extended care network to care for a care receiver via a care management server by using care receiver clients and sensors is illustrated. Likewise, as illustrated in FIG. 1C, care providers, either individually or as part of an extended care network can care for a care receiver via a care management system by using care receiver sensors or care receiver clients (CRCs) in accordance with an embodiment of the invention. As can readily be appreciated, care management systems in accordance with embodiments of the system can be deployed by a single care provider network or can be deployed for use by multiple care provider networks. Accordingly, the manner in which the care management system is deployed is largely a function of the requirements of a specific application.

The care management server collects information from the care receiver client and the various care receiver controllers and care receiver sensors. The information collected by the care management server can be utilized in the provision of care to the care recipient including (but not limited to) by providing alerts and/or reminders to the care recipient and/or a care provider and/or third party. In many embodiments, the care receiver controllers and care receiver sensors communicate wirelessly with the hub. In several embodiments, the care receiver controllers and care receiver sensors can utilize wireless communication technology similar to the technology utilized in home security systems. The information collected by the controllers and sensors can then be aggregated and transmitted via a cellular data network by the wireless gateway, which can be implemented using a machine-to-machine communication technology. Examples of machine-to-machine communication technology include cellular network backhaul systems. A network backhaul system can utilize existing cellular network infrastructure and/or broadband service providers. These communication technologies can be implemented in a similar manner to home security solutions, which are a closed and propriety platform unique to each vendor and utilize a home based gateway device with a monthly service charge to route the data and control information between a suite of pre-integrated device sensors and the care management server. These communication technologies can also be facilitated by wireless gateway technology such as 2Net provided by Qualcomm, Incorporated of San Diego, Calif. Qualcomm's 2Net is a privately controlled network with a purpose independent information bridge implemented in a quasi-open architecture.

The care receiver client is typically constrained to limit the user interface available to the care receiver and is configured to communicate to the care management server via the Internet. In many embodiments, the care receiver client relies upon a separate Internet connection to the wireless gateway utilized by the controllers and sensors that also form part of the care receiver's care management system. The manner in which the care management server aggregates information collected via the Internet from controllers and sensors and assists with the provision of care to care receivers in accordance with embodiments of the invention is discussed further below.

A care provider client can provide settings for the care management server. The care management server saves the settings in a care management database and applies the settings on care receiver devices, including (but not limited to) a care receiver client and/or a care receiver sensor. Also, the care receiver client may use a wireless broadband network to communicate with care receiver sensors or a network, such as through Wi-Fi with DSL or Cable Modem Internet access instead of the gateway device. In several embodiments, the care receiver client devices return data to the care management server, which the care management server can store in the care management database. Care receiver clients can operate in online or offline modes. Care receiver clients operating in offline mode store data locally and the care receiver client synchronizes with the care management server when online.

The care management server can perform analytics upon the data in the care management database to determine when to send notifications to the care receiver client, care provider client or a third party including an Internet content server. For example, game performance (potentially indicative of cognitive function) in games played via the user interface of a client receiver device can be sent to a care management server and logged in a care management database. The care management server can perform analytics on the game performance to determine if there is abnormal performance or any other characteristic that triggers a notification. If a notification is triggered, the notification can be sent to a care provider client or via any of a variety of communication technologies including but not limited to care provider client dashboard status, email, SMS, or automated telephone message.

In many embodiments, the care management server facilitates communication between the devices, including data exchange, analytics of data, notification and authorization to access data. In many embodiments, communication between care provider clients and care receiver sensors are routed through the care management server, which stores the settings that the care receiver controller is running in a care management database. Likewise, data exchange between care receiver devices and a care provider client is routed through a care management server which stores the data from the care receiver sensor in a care management database that can be relayed back to the care provider client. In several embodiments, the care management server controls the care receiver client's access to data and applications, such as web email services or videoconferencing applications. In many embodiments, the access granted to a care receiver client by the care management server can be configured by the care provider client.

In several embodiments, the analysis of care receiver device data can include analysis of care receiver device data stored in the care management server to determine whether any dangerous or undesirable condition is present, such as (but not limited to) a care receiver's house being too cold, an open door, a trend of poor performance on games or missing an appointment on the care receiver's calendar. Notifications can include notifying a care provider client or third party when situations of interest, including dangerous or undesirable conditions occur.

In numerous embodiments, the care provider client determines the settings of the care management server and receives updates from the care management server. The care provider client can create settings on the care management server. These settings include the user interface on a care receiver client as well as the data that a care receiver client can access, the settings on care receiver controllers, the analytics performed by a care management server and the types of notifications generated by the care management server.

Care management servers in accordance with many embodiments of the invention can load a care management process as machine readable instructions from non-volatile memory stored in a care management server. A care management process loaded from non-volatile memory configures a processor to manage the care of care receivers in accordance with an embodiment of the invention is illustrated in FIG. 1D. The care management server 150 includes a processor 152, volatile memory 154 and non-volatile memory 158 that includes a care management process 156. In the illustrated embodiment, the non-volatile memory is a machine readable media that is utilized to store the machine readable instructions that configure the processor. The non-volatile memory 158 contains the instructions (156), as a care management process 156, utilized to configure the processor 152 of a care management server to care for a care receiver. In many embodiments, care management processes can be loaded from any kind of memory including volatile memory in accordance with many embodiments of the embodiment.

Although a care management system is described above with respect to specific care management servers communicating with a care management database, internet content servers, care provider clients, care receiver clients and care receiver sensors, any of a variety of care management systems can be utilized to manage the care of a care receiver as appropriate to specific applications in accordance with many embodiments of the invention.

### Updating Care Receiver Clients and Sensors

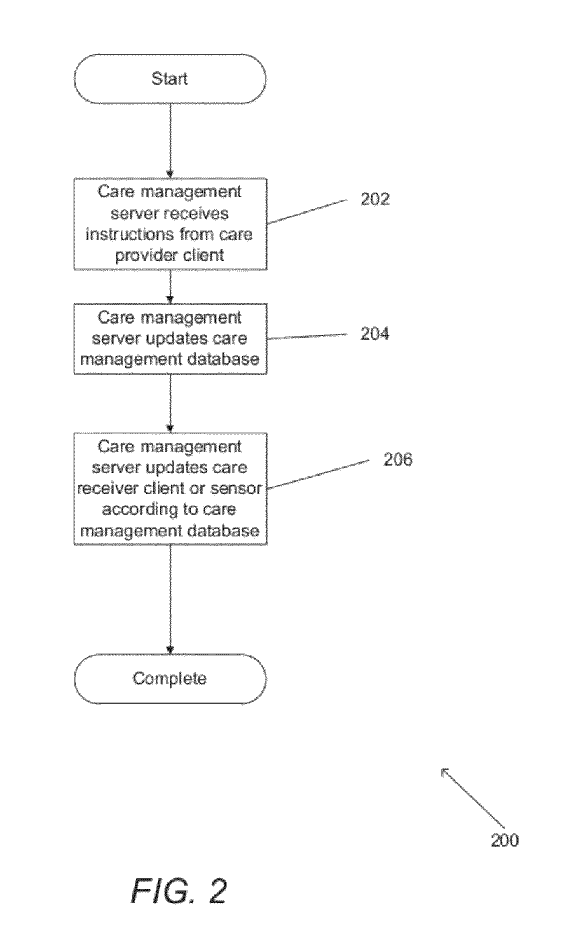

Care receiver clients and sensors have settings that are determined either by care providers, care receivers or the settings within a care management server. In many embodiments, care receiver clients and sensors are directly updated utilizing the settings on a care receiver server which can be controlled by care provider clients or care receiver clients. A flow chart illustrating a process for updating care receiver clients or sensors based upon care provider instructions using a care management server in accordance with an embodiment of the invention is illustrated in FIG. 2. The process 200 begins with the care management server receiving (202) instructions from a care provider client. After receiving (202) instructions, the care management server updates (204) a care management database. After updating (204) the care management database, the care management server updates (206) a care receiver client, controller and sensor according to settings stored within a care management database.

In many embodiments, the care management server receives instructions from a care provider client, which can include settings for care receiver clients or sensors, such as temperature settings in a care receiver's environment or reminders scheduled in a calendar. In several embodiments, same or similar settings can also be configured by care receiver clients.

In certain embodiments, settings are configured for the care receiver device, including but not limited to settings for games, email accounts, websites to access or contacts that a care receiver can access on a care receiver client. In which case, the care management server updates a care management database of settings for devices. The care management server can then update relevant devices based upon the settings associated with the devices in the care management database, when the devices are next in communication with the care management server.

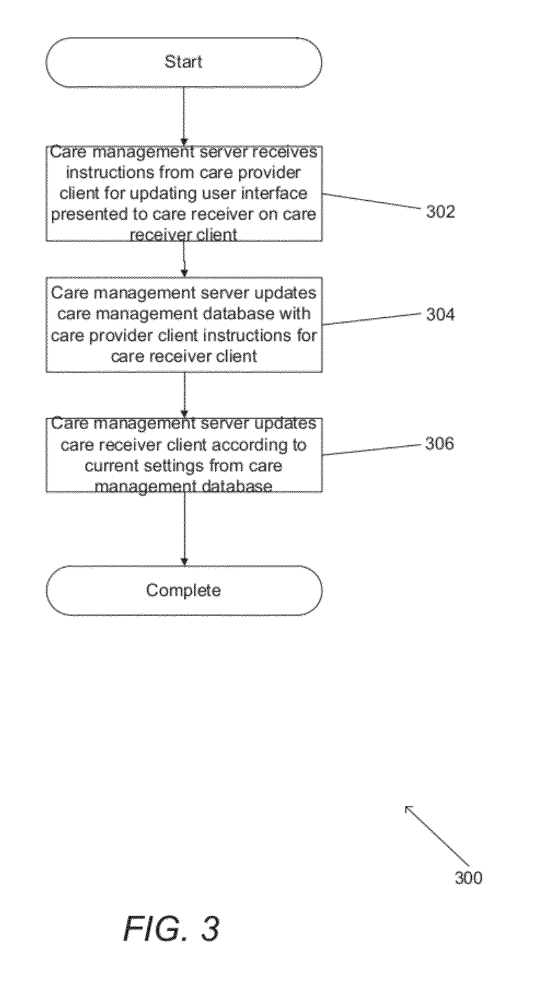

A further example of a process for updating care receiver clients or sensors using a care management server includes updates to a user interface on a care receiver client in accordance with an embodiment of the invention as illustrated in FIG. 3. The process 300 begins with a care management server receiving (302) instructions from a care provider client for updating a user interface presented to a care receiver on a care receiver client. After the care management server receives (302) instructions, the care management server updates (304) a care management database with the care provider client instructions for the care receiver client. After updating (304) the database, the care management server updates (306) the care receiver client according to the current settings from the care management database.

In many embodiments, a care management server receives instructions for updating an interface for a care receiver on a care receiver client. These instructions can be specific to features on a care receiver client, such as settings for the care receiver client's user interface, games playable on the care receiver client or other features that the care receiver can access on the care receiver client.

In several embodiments, a care receiver client can be a telephone with telephonic or numerical input with auditory instructions from the telephone. The care receiver client can then update the care management database and update other care reliever clients or care provider clients, such as a computer or an Internet connected TV. A process for telephonic input on a care receiver client can include an instruction as to select the data to input into the telephonic care receiver client such as (but not limited to) a care receivers weight, blood pressure, glucose level, pulse or oxygen readings. After the selection of data to input, an instruction is given to input the data numerically via the telephone. A telephonic care receiver client can also be utilized to fill out a questionnaire where data can be entered as a yes or no answer, where a certain numerical input via a telephone key pad is deemed to be a “yes” and another is deemed to be a “no.” Confirmation of selections can be made after each part of the process. Additionally, a time limit can be place upon telephonic input of an arbitrary amount such as 10 seconds. Furthermore, validation and error checking can be in place for inputted telephonic data such as whether a plausible weight was entered. In this way, measurements concerning the status of a care recipient can be taken using conventional measurement devices and/or instruments (i.e. devices that do not communicate with a care management server) and the measurements provided to the care management server via a telephone user interface. Furthermore, questions can be asked by the user interface to obtain information that may be used in the normalization of the care recipient status data provided to the care management system. In several embodiments, either care receiver or care provider clients are telephonic. In many embodiments, data collected via automated telephone interaction can be supplemented with data obtained via other sensors. In a number of embodiments, the automated telephone interaction prompts the care recipient to utilize a sensor to provide information to the care management system. The collection of data and the analysis of data by care management systems in accordance with embodiments of the invention is discussed further below.

### Tracking Medications and Appointments

Care management servers in several embodiments can track and manage reminders for care receivers such as events, meetings or activities. In many embodiments, a care receiver client can record and implement settings and notifications within a schedule stored within a care management database or locally stored within a care receiver client that can synch with a schedule in a care management database.

In several embodiments, the care management server creates and tracks reminders associated with specific medications and/or specific measurements that the care recipient is meant to take using either using sensors collected to the care management server or disconnected sensors that the care recipient uses and then reports the acquired measurements to the care management server via the care recipient client and/or an interactive telephone system. In many embodiments, the care management server receives updates from the care recipient in the manner outlined above and matches the information in the updates to the reminders. For example, receipt of a weight measurement can be utilized to automatically cancel the generation of a reminder to measure weight. In other instances, any of a variety of different updates can be processed by the care management server and utilized to modify and/or cancel generation of reminders.

Scheduling in accordance with numerous embodiments of the invention allows a user to create events related to appointments, and to set reminders for the created events. These reminders can take into account the context of the event, such as automatic modification of reminders based on one or more of traversal distance of the event location from a current location of the care receiver, real time traffic reports or projected traffic based upon time of day, or updated weather reports. In several embodiments, scheduling can be used to create events and invite people including those that do not have access to the same scheduling application used to create the event. Further, the scheduling may generate reminders via different modalities including device-based alerts, messaging, telephone calls, SMS, or e-mail. Scheduling can also feature different escalation points such as when confirmations are not received so that if an e-mail or device based reminder is not responded to within a limited time period (5 minutes for example) it is followed up by a call. In certain embodiments, schedules can be operated offline with data cached and synched with a care management server when a connection with the care management server is achieved.

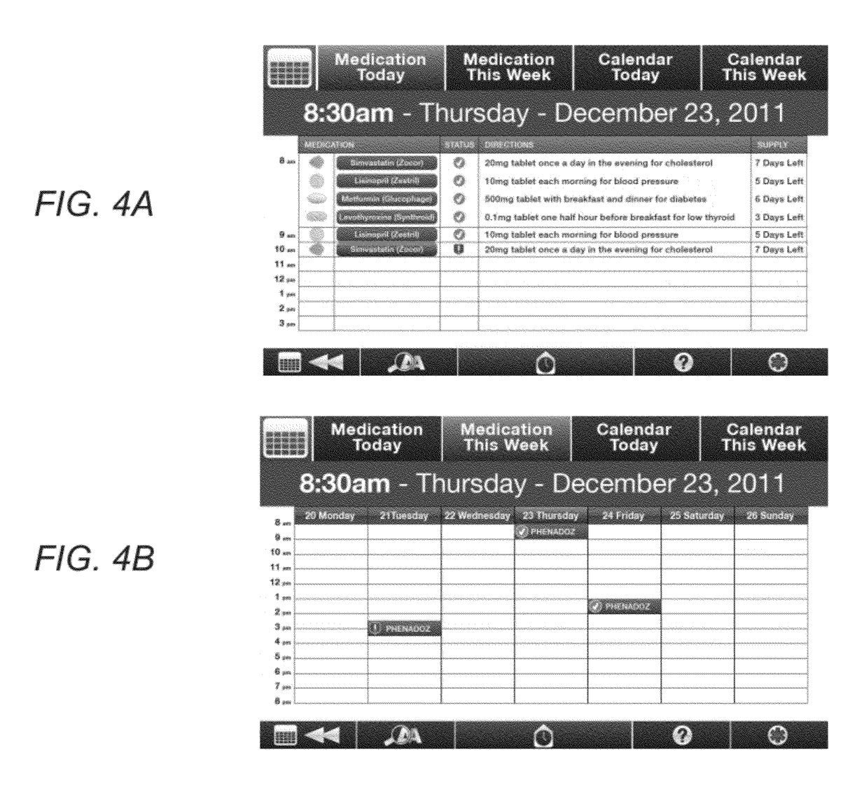

In several embodiments, care receiver clients can inform a care receiver as to the schedule of medications that a care receiver should be taking. FIG. 4A illustrates a daily medication schedule on a care receiver client in accordance with an embodiment of the invention. This medication schedule includes both the medication and the time, status, supply of medication and directions for the administration of the medication. Likewise, FIG. 4B illustrates a weekly medication schedule on a care receiver client in accordance with an embodiment of the invention.

In many embodiments, a care management server receives instructions for updating the medication list on a care receiver user interface. The care management server then sends the updated medication list to the care receiver client. In certain embodiments, if a care receiver client is offline, the care management server will use alternative means, such as a phone or email to remind or alert a care receiver to administer the medication. A care receiver client can also operate offline, such as in certain embodiments where a care receiver client will capture locally acquired data such as inputs to the care receiver device or data from care receiver sensors and cache the data until the care receiver client is next online.

In many embodiments, a care management database includes a database for selecting medications or drugs. This database of drugs is built over time and is based upon relevance such as whether certain drugs are interchangeable with others and can include information concerning uses for certain drugs. In several embodiments, a third party drug database is used to help care providers or care receivers pick from a list of matching drug names as they start entering the drug. In one embodiment, the database thereby makes it easier to enter in a drug name by automatically filling out the name as a user types it in. A user can still enter in a name of a drug if the drug is not in the database and the new drug name is added to the care management database in the cloud. In one embodiment, a new drug is sorted in a database of drugs based on frequency of use of the same drug name by multiple users, such as care providers or care receivers. Assessments of drug use based upon frequency addresses both typographical errors (as even though the intended drug may be in the database, typographical errors may cause the drug name not to appear in the list to be picked) as well as actual drug names, which may be missing from the database. In one embodiment, “Edvil” can be a misspelling of “Advil”. “Advil” is a brand of ibuprofen manufactured by Pfizer Incorporated, based in New York City, New York. The frequency of entries of “Edvil” will determine whether this new term is added to the database. In one embodiment, if three entries or less occur over a period of six months, the new term is not added to the database of drugs shared by a common care management database, but those three individual users would have the new term in their own list of drugs. However, if more than three people added the new term within six months, this may be a new drug that is not added to the care management database's section for drugs and therefore can be added to a common care management database for multiple users. Although specific numbers of users and periods of time are referenced above, the criteria for adding a new term to the database can be determined based upon the requirements of a specific care management system.

In many embodiments, a care management server manages reminders for events in a schedule. In certain embodiments, a user interface uses a time-line to manage upcoming reminders, distinguishing between events that are closer and farther away in time. In several embodiments, reminders on a care receiver client user interface moves toward a now mark on a time-line displayed via the user interface as time goes on. Hitting a now option on a care receiver client user interface associated with the reminder can cause a visual reminder of a distant event to move away from now and ultimately off the screen. If the reminder is “completed”, then the reminder on the user interface moves forward with a checkmark and no further escalations are applied. If not, the lack of completion of the reminder can have escalation rules applied. The escalation rules govern how different alerts are generated that call attention to a task that has not been completed, such as generating alert noise or pop up reminders on a user interface. In many embodiments, failure to confirm that a reminder is “completed” can result in an alert being provided to a care provider by the care management server in the manner discussed above. Notification and alert escalation in accordance with embodiments of the invention is discussed further below.

### Notifications and Alert Escalation

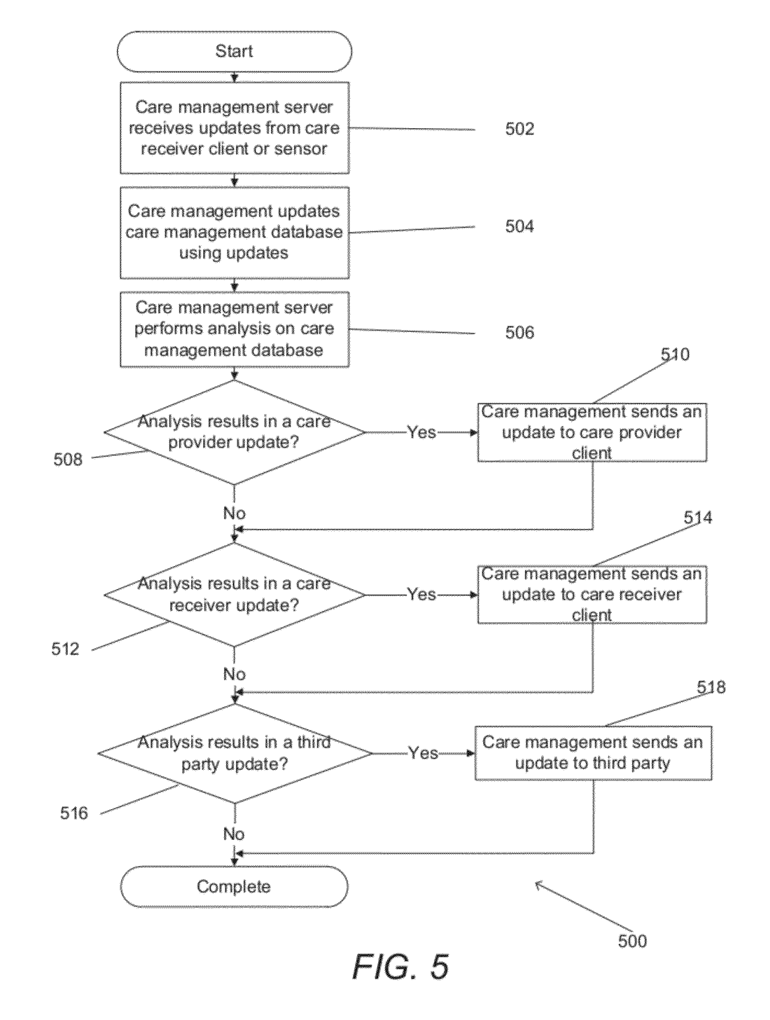

A care management server aggregates data from care receiver clients and sensors, care provider clients and/or third parties for analysis and can generate alerts for and/or update care receiver clients and sensors, care provider clients and third parties in accordance with various embodiments of the invention. The data is typically aggregated within the care management database and analytics can be performed upon the data utilizing the processer in the care management server. A flow chart illustrating a process performed by a care management server to send notifications to a care receiver client or a care provider client in accordance with an embodiment of the invention is illustrated in FIG. 5. The process 500 begins with a care management server receiving an update (502) from a care receiver client or a sensor. After receiving the update (502), the care management server updates (504) a care management database based upon the update (502) from the care receiver client or sensor. After updating a care management database (504), the care management server performs analysis (506) on the care management database. After analyzing (506) the care management database, a decision (508) is made as to whether the analysis necessitates a care provider update. If the analysis directs that a care provider should receive an update, then the care management server sends (510) an update to a care provider client. Another decision (512) is then made as to whether the care receiver should also receive an update. If the analysis result in a care receiver update, then the care management server sends (514) an update to the care receiver client and a decision is made as to whether the analysis results in a third party update. If the analysis results in a third party update, then the care management server sends (518) an update to a third party. If the analysis does not result in a third party update, the then process is complete. As can be appreciated, decisions concerning whether to update various care receivers, care providers, and/or third parties can be made independently.

In many embodiments, the care management server can receive updates from care receiver devices related to changes in the environment, such as temperature changes or time/date changes; or changes in security or well being, such as open/closed doors or unresponsiveness to telephone calls. The care management database stores data from the care receiver devices for analysis that can result in updates for either the care provider, care receiver, or care receiver devices.

In many embodiments, analysis of data in a care management database can incorporate custom thresholds set by a care provider. In certain embodiments, Boolean and value range functions are used that apply a single alert type if a threshold is met. In one embodiment, a set of complex range functions can be set. For example, the range function could incorporate requirements including (but not limited to) where if the inside temperature in a care receiver environment is <70 and bathroom visits yesterday were >10 and the care receiver was inside all day and the fridge door was not opened all day and the care receiver rose out of bed >3 hours past her normal time, then an alert is generated and sent to a care provider client. Alerts can come at different levels indicating the seriousness of the alert. In many embodiments, a red alert can be an alert indicating high seriousness and a green alert can indicate an alert of low seriousness. Combinations of factors can be considered in the generation of alerts. For example, if a care receiver has not picked up a reminder call and the care receiver is indoors and there is no motion >4 hours during the day, then a red alert update is sent to a care provider client. In other embodiments, any of a variety of pieces of information collected via the care receiver devices can be utilized in evaluating whether to generate an alert.

In many embodiments, analysis of data in a care management database can generate threshold escalation. In several embodiments, threshold escalation occurs if the same threshold occurs more than a predetermined number of times defined by a care provider. In which case, the alert can escalate from a current alert level to a higher alert level. For example, in several embodiments, a care receiver failing to step on a scale all day is a yellow alert. However, if the care receiver has not stepped on a scale all day for a certain number of days set by the care provider, such as 3 days, then the alert moves to a higher level. As indicated above, the factors that are considered in generating and escalating alerts can be customized by the care provider via a user interface provided by the care management server.

In several embodiments, analysis of data in a care management database generates multiple alert thresholds. In certain embodiments, escalation moves by multiple threshold levels and not just one threshold level where the analysis detects a significant change. In one embodiment, a situation matching a situation escalation but indicative of a more serious issue, such as an immediate threat to the well being of a care receiver, can move immediately from no alert to the highest alert level.

In a number of embodiments, the data stored in the care management database with respect to a number of care recipients can be used to detect patterns indicative of a likelihood of a particular status. So called “predictive analytics” can be enhanced by combining the status data with healthcare outcome data. In this way, the data can be used to provide notifications of the detection of a pattern associated with a particular status and/or potential healthcare outcome.

### Care Receiver Client User Interface

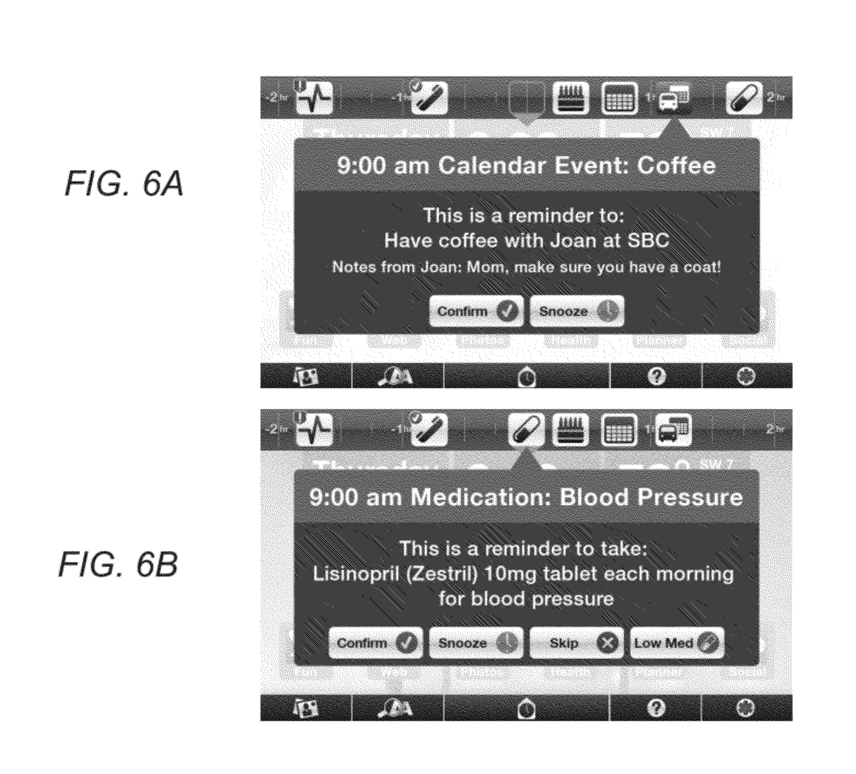

A care receiver client can enable a care receiver to interact with the care management server and can display data of interest for a care receiver in accordance with embodiments of the invention. In numerous embodiments, a care receiver client includes reminders for events or medication for administration to a care receiver. FIG. 6A illustrates the display of a reminder on a care receiver client user interface in accordance with an embodiment of the invention. Likewise, FIG. 6B illustrates the display of a reminder for a care receiver to take medicine in accordance with an embodiment of the invention. In many embodiments, care receiver devices can detect changes or perform periodic updates. For example, in certain embodiments, a care receiver device detects whether the care receiver has sent out oxygen level information. When the care receiver device detects a status of oxygen level information, the care receiver device sends that information to a care management server, which updates a care management database. The care management server then performs analytics determining whether the oxygen level information is absent and if the absence is noteworthy for the care receiver, will send a notification to the care receiver client that will alert the care receiver concerning the need to obtain an oxygen level measurement.

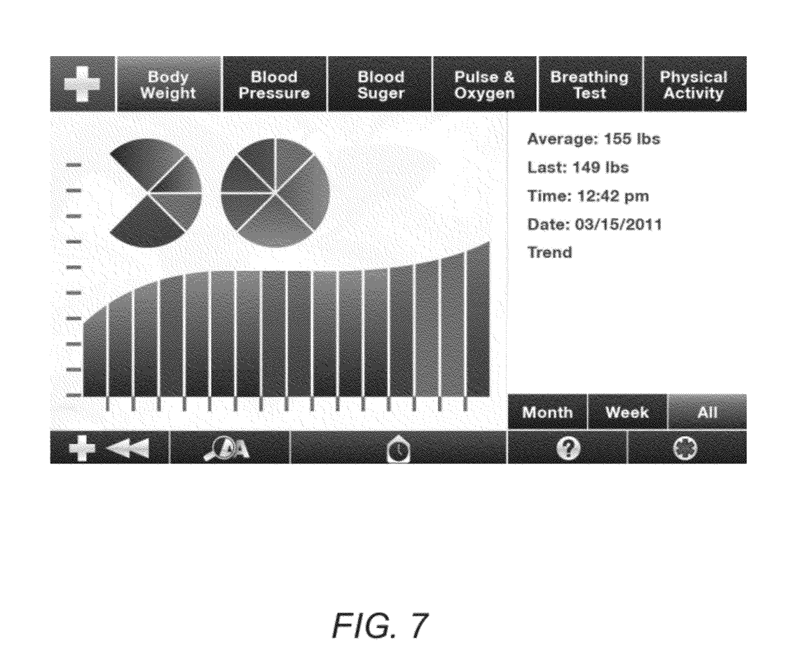

Data of interest to a care receiver can also be displayed on a care receiver client in many embodiments. Data of interest can include the status or updates from care receiver sensors or analyzed data regarding the care receiver. Body weight data concerning a care receiver as displayed on a care receiver client in accordance with an embodiment of the invention is illustrated in FIG. 7. In the illustrated embodiment, details concerning body weight are displayed such as body weight average and the last body weight measurement as well as a graph illustrating body weight measurements plotted across different measurement times. In various embodiments, data of interest can also be displayed on a care provider device or on a third party client.

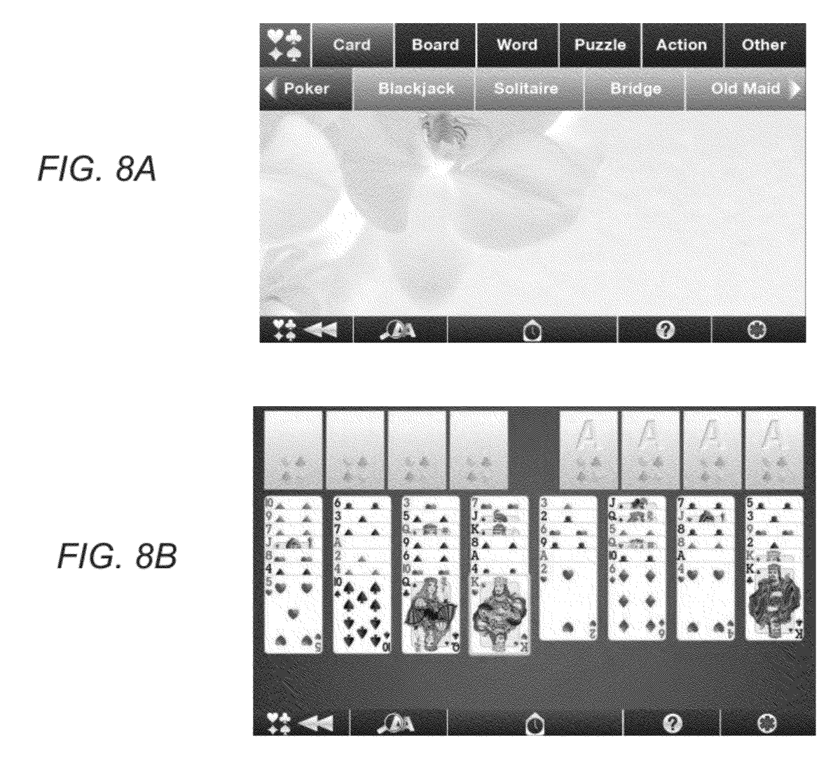

Additionally, games can be utilized on a care receiver client for entertainment. A graphical user display of games that a care receiver can play on a care receiver client in accordance with an embodiment of the invention is illustrated in FIG. 8A. In the illustrated embodiment, a care receiver can browse among various different genres and types of games. Additionally, in many embodiments, the cognitive function of a care receiver can be monitored by observing the care receiver's ability at playing various games. A significant drop in performance can often be indicative of a decline in status. In many embodiments, a care receiver can use a care receiver client to play a multiplayer game with other players. The care provider or care management server can set the options for game play such as access to the game or access to game settings. FIG. 8B illustrates a card game played via a care receiver client user interface in accordance with an embodiment of the invention. In the illustrated embodiment, a care receiver can choose to play a single player game of solitaire.

In a number of embodiments, a strong trend of winning followed by a gradual but firm trend of losing games can be indicative of dementia in certain cases. Data from game play can be sent from the care receiver client to a care management server. The care management server can update a care management database with data on game play and perform analysis on the care management database. The analysis can indicate whether an update or an alert should be sent to a care provider. The analysis can also indicate whether a third party should be updated.

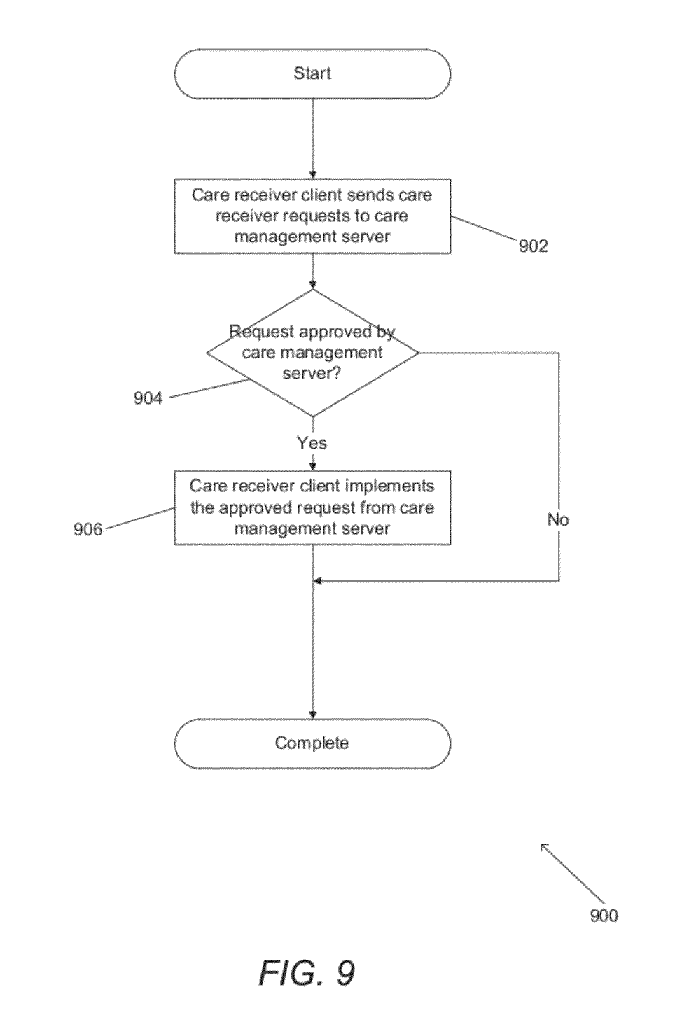

In several embodiments, a care receiver client can request data from a care management server such as to browse the Internet, play games, teleconference, or to send or receive data. Requests can also include accessing email, social media, or the news. These requests are in turn moderated by the care management server. A flow chart illustrating a process for a care receiver client sending a request to a care management server, where the care receiver client implements the care receiver client request that is approved by a care management server in accordance with an embodiment of the invention is illustrated in FIG. 9. The process 900 begins with a care receiver client sending (902) a care receiver request to a care management server. After the care receiver request is sent, a decision (904) is made as to whether the request is approved by the care management server. If the request is approved by the care management server, then the care receiver client implements (906) the approved request from the care management server. If the request is not approved by the care management server, the process is complete and no action takes place.

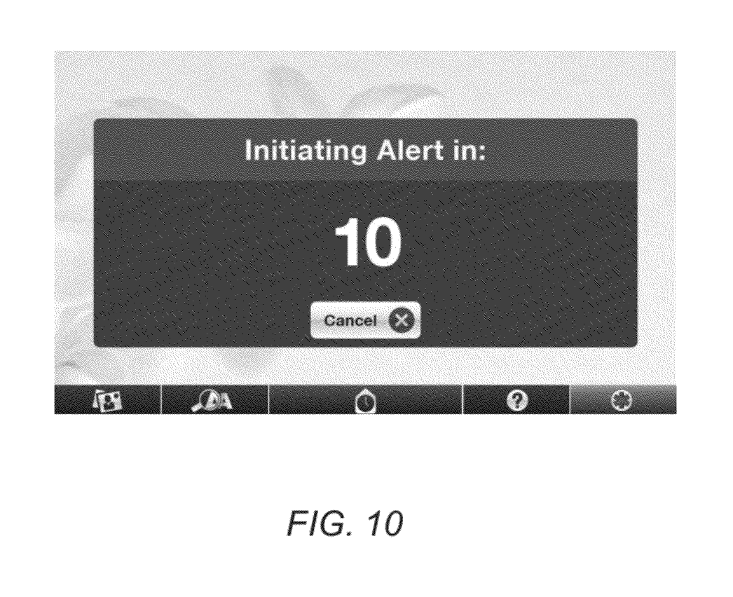

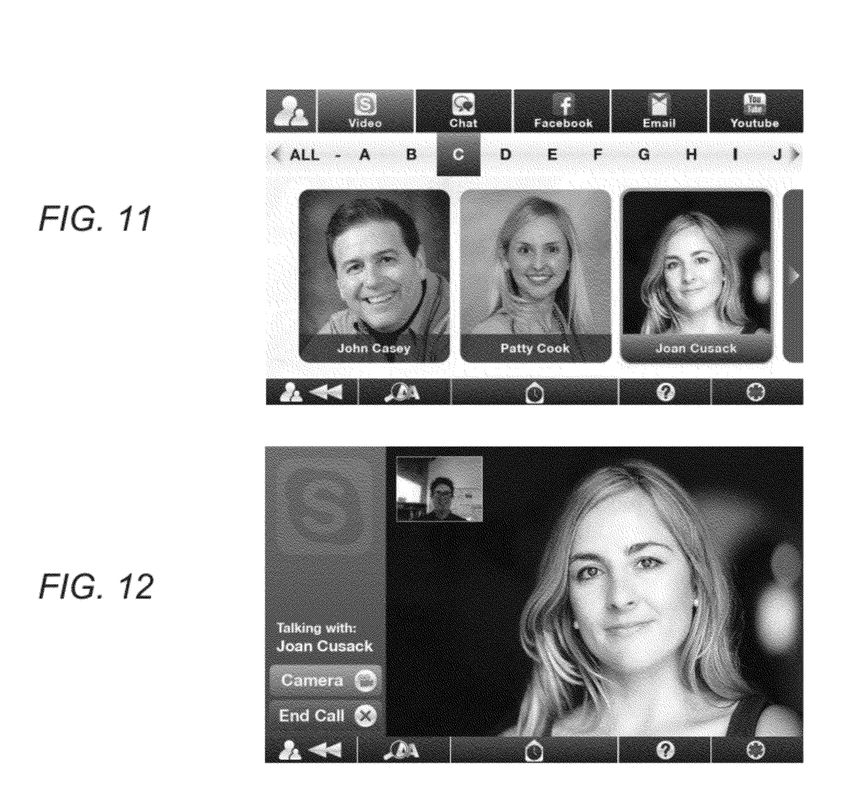

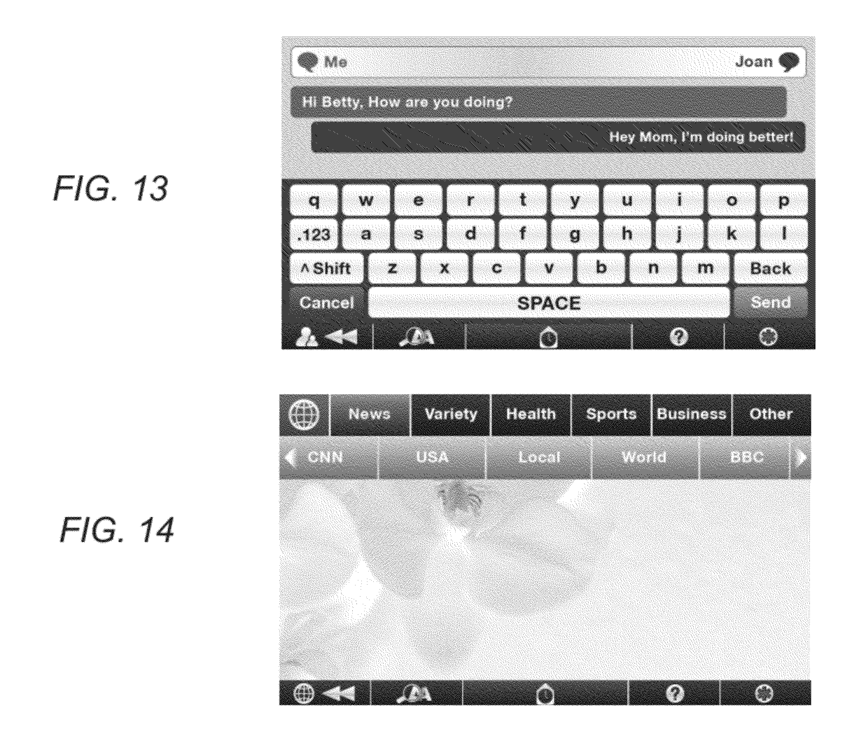

In various embodiments, a care receiver may want to communicate with a care provider such as in sending an alert or a call for help. An alert in accordance with an embodiment of the invention is illustrated in FIG. 10. In the illustrated embodiment, the alert can be initiated after an arbitrary amount of time, such as 10 seconds, to ensure that the care receiver actually meant to call for the alert. Similarly, a care receiver may seek to communicate with a care provider or a third party in another fashion. A user interface illustrating a video conference list in accordance with an embodiment of the invention is illustrated in FIG. 11. In the illustrated embodiment, pictures of the contacts are illustrated for ease of use for the care receiver. A videoconference performed via a care receiver client user interface in accordance with an embodiment of the invention is illustrated in FIG. 12. In the illustrated embodiment, a care receiver can control the videoconference such as by ending the call. Likewise, a care receiver can engage in text communication as well. Text communication from a care provider using a touch keypad on a care receiver client in accordance with an embodiment of the invention is illustrated in FIG. 13.

A care receiver can also interact with third parties for information of interest to the care receiver, such as the news. A user interface for selecting news or other sources of data from a third party provider in accordance with an embodiment of the invention is illustrated in FIG. 14. In the illustrated embodiment, news or any other source of information of interest to the care receiver can be selected on the user interface. Thereby, the care receiver can manage information on a news service website.

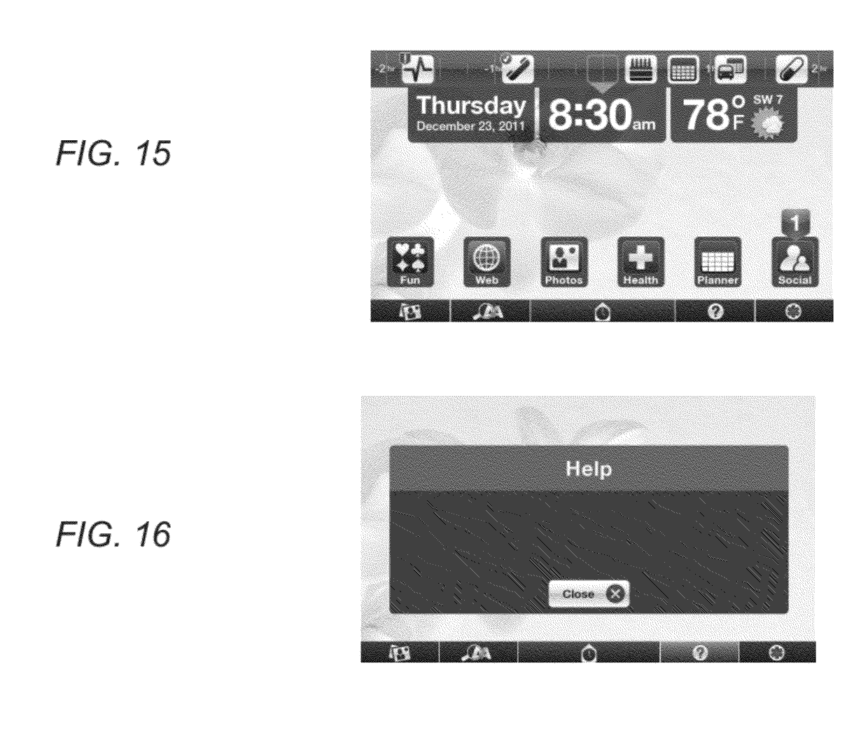

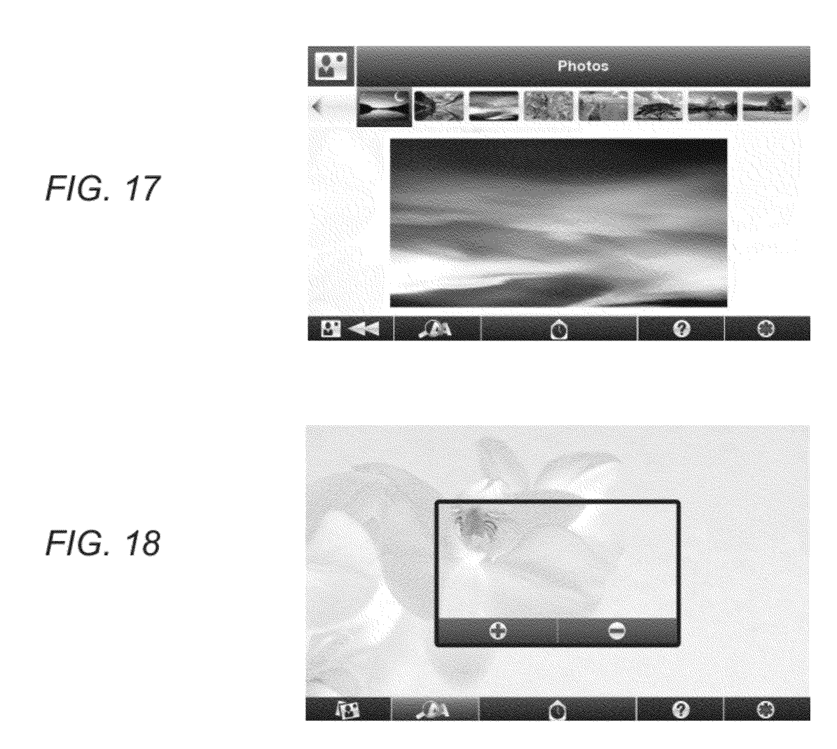

In many embodiments, a care receiver navigates a user interface on a care receiver client to engage in an activity. The care receiver client can send a care receiver request to engage in that activity to a care management server. The care management server determines whether it approves the care receiver request. If the request is approved, the care receiver client implements the request for the activity and the activity proceeds. If not, then the process is complete and the activity does not proceed on the care receiver client. The activity can be a video conference, managing email or a social network, interacting with a webpage or browsing the news. The user interface can also include information generally of interest to the care receiver such as the time or weather. A user interface with information of general interest to a care receiver in accordance with an embodiment of the invention is illustrated in FIG. 15. Additionally, the user interface can also provide access to a help screen that allows for the care receiver to more easily navigate the user interface. A help screen on a care receiver client in accordance with an embodiment of the invention is illustrated in FIG. 16. A user interface can also include general features that are useful for a care receiver or that make a care receiver client more easy to use for the care receiver. Photo viewing on a care receiver client in accordance with an embodiment of the invention is illustrated in FIG. 17. In the illustrated embodiment, a number of photos can be viewed in thumbnails for ease of use. A zooming feature on a care receiver client in accordance with an embodiment of the invention is illustrated in FIG. 18. In the illustrated embodiment, a section of the care receiver client's graphical user interface can be selected and either zoomed in or out based upon the care receiver's instructions.

While the above description contains many specific embodiments of the invention, these should not be construed as limitations on the scope of the invention, but rather as an example of one embodiment thereof.

What is claimed is:

1. A care management system, comprising:
a care management server configured to communicate with:
at least one care provider client, where the care provider client is configured to provide a user interface for receiving care management instructions;
wherein the care management server is configured to:
receive care management instructions from the at least one care provider client and store the care management instructions in a care management database;
receive data concerning the status of a care recipient and store the received data concerning the status of the care recipient in the care management database;
analyze the data concerning the status of the care recipient within the care management database in accordance with the care management instructions; and
send notifications to the care provider client based upon the analysis of the care management database.

2. The care management system of claim 1, wherein the care management server is further configured to:
receive data concerning the status of a care recipient using automated user interface interactions via a telephone; and
send automatically generated notifications to the telephone based upon the analysis of the care management database.

3. The care management system of claim 1, wherein the care management server is further configured to:
receive data concerning the status of a care recipient via a care receiver client; and
send notifications to the care to the care receiver client based upon the analysis of the care management database.

4. The care management system of claim 3, wherein:
the care receiver client is configured to access content servers; and
the care management server is configured to restrict the content servers that the care receiver client can access.

5. The care management system of claim 3, wherein:
the care receiver client is configured to:
display a game user interface;
record game performance; and
send game performance data to the care management server; and
the care management server is further configured to:
receive game performance data from the care receiver client and store the game performance data in the care management database;
analyze the game performance data; and
send a notification to a care provider client in response to the analysis detecting a decline in game performance.

6. The care management system of claim 1, wherein the care management server is further configured to receive data concerning the status of a care recipient via a care receiver sensor.

7. The care management system of claim 1, wherein the care management server is further configured to communicate with at least one of a care receiver client, a care receiver sensor and a care provider client via the Internet.

8. The care management system of claim 7, wherein the at least one of a care receiver client and a care receiver sensor are configured to connect to the Internet using a wireless hub.

9. The care management system of claim 1, wherein:
the care management server is further configured to receive data concerning the status of a care recipient via at least one of a care receiver client, and a care receiver sensor; and
the care management server is configured to update the configuration settings of the at least one of a care receiver client and a care receiver sensor based upon the analysis of the data concerning the status of the care recipient in the care management database.

10. The care management system of claim 1, wherein at least one of a care provider client, a care receiver client, and a care receiver sensor are configured to intermittently synchronize with the care management server.

11. The care management system of claim 1, wherein the care management server receives scheduling data from a care receiver client.

12. The care management system of claim 1, wherein the care management database includes a database of pharmaceuticals.

13. The care management system of claim 1, wherein the care management server is further configured to:
analyze the data within the care management database to generate a timeline of upcoming notifications; and
send the timeline of upcoming notifications to at least one of a care receiver client and a care provider client, which displays a timeline of upcoming notifications via a user interface.

14. The care management system of claim 1, wherein the care management server is configured to analyze the data within the care management database and send escalated notifications based upon the care management instructions stored in the care management database.

15. The care management system of claim 1, wherein the care management server is further configured to:
store data concerning the status of a plurality of care recipients in the care management database; and
perform analytics to detect patterns that can be used to detect an increased likelihood of a particular status for a specific care recipient in the future.

16. A method of managing the care of care receivers using a care management server, the method comprising:
receiving care management instructions from a care provider client using a care management server and storing the care management instructions in a care management database;
collecting data concerning the status of a care recipient using a care management server and storing the data concerning the status of the care recipient in the care management database;
analyzing the data concerning the status of the care recipient within the care management database in accordance with the care management instructions stored in the care management database; and
sending notifications to the care provider client based upon the analysis of the care management database.

17. The method of claim 16, further comprising receiving data concerning the status of a care recipient using automated user interface interactions via a telephone and sending automatically generated notifications to the telephone.

18. The method of claim 16, further comprising receiving data concerning the status of a care recipient via a care receiver client and sending notifications to the care receiver client.

19. The method of claim 18, wherein the care receiver client is configured to access content servers, and the method further comprises restricting the content servers that the care receiver client can access using the care management server.

20. The method of claim 18, further comprising:
displaying a game user interface using the care receiver client;
recording game performance using the care receiver client;
sending game performance data to the care management server using the care receiver client;
receiving game performance data from the at least one care receiver client using the care management server and storing the game performance data in the care management database;
analyzing the game performance data using the care management server; and
sending a notification to a care provider client in response to the analysis detecting a decline in game performance using the care management server.

21. The method of claim 16, further comprising receiving data concerning the status of a care recipient via a care receiver sensor.

22. The method of claim 16, further comprising communicating between the care management server and at least one of a care receiver client, a care receiver sensor and a care provider via the Internet.

23. The method of claim 22, further comprising connecting at least one of a care receiver client, and a care receiver sensor to the Internet via a wireless hub.

24. The method of claim 16, further comprising:
receiving data concerning the status of a care recipient via at least one of a care receiver client, and a care receiver sensor using the care management server; and
updating the configuration settings of the at least one of a care receiver client and a care receiver sensor based upon the analysis of the data concerning the status of the care recipient in the care management database using the care management server.

25. The method of claim 16, further comprising at least one of a care provider client, a care receiver client, and a care receiver sensor intermittently synchronizing with the care management server.

26. The method of claim 16, further comprising receiving scheduling data from a care receiver client using the care management server.

27. The method of claim 16, wherein the care management database includes a database of pharmaceuticals.

28. The method of claim 16, further comprising:
analyzing the data within the care management database to generate a timeline of upcoming notifications using the care management server; and
sending the timeline of upcoming notifications to at least one of a care receiver client and a care provider client, which displays a timeline of upcoming notifications via a user interface.

29. The method of claim 16, further comprising analyzing the data within the care management database and sending escalated notifications based upon the care management instructions stored in the care management database using the care management server.

30. The method of claim 16, further comprising:
storing data concerning the status of a plurality of care recipients in the care management database; and
performing analytics on the data stored in the care management database using a care management server to detect patterns that can be used to detect an increased likelihood of a particular status for a specific care recipient in the future.
